(19) United States
(12) Patent Application Publication
(10) Pub. No.: US 2014/0105794 A1
(43) Pub. Date: Apr. 17, 2014

(54) Nano-Pipet Fabrication

(71) Applicant: INTERNATIONAL BUSINESS MACHINES CORPORATION, Armonk, NY (US)

(72) Inventors: Stefan Harrer, New York, NY (US); John A. Ott, Greenwood Lake, NY (US); Stanislav Polonsky, Putnam Valley, NY (US)

(73) Assignee: International Business Machines Corporation, Armonk, NY (US)

(21) Appl. No.: 13/671,282

(22) Filed: Nov. 7, 2012

Related U.S. Application Data
(63) Continuation of application No. 13/651,494, filed on Oct. 15, 2012.

(51) Int. Cl. B01L 3/02; B29C 67/00; B82Y 99/00

(52) U.S. Cl. 422/501; 425/174.4; 977/904

(57) ABSTRACT

A hollow high aspect ratio sample, such as a nano-test-tube, with a tip that is closed off is secured in a particle beam device, such as a transmission electron microscope. The tip is engaged with the particle beam of the particle beam device until a hole opens up on the tip, thereby turning the high aspect ratio sample into a nano-pipet. Alternatively, a nano-pipet having a hole that does not meet desired parameter values is secured in a particle beam device. The nano-pipet is engaged with the particle beam to attain the desired values of the hole parameters.

### CROSS REFERENCE TO A RELATED APPLICATION

This application is a Continuation of application Ser. No. 13/651,494, filed Oct. 15, 2012, which is incorporated herein by reference in its entirety.

### BACKGROUND

The present invention relates to nano-structures capable of molecular scale influences. In particular it relates to devices containing a small opening, such as nano-pipets.

### BRIEF SUMMARY

A hollow high aspect ratio sample, such as a nano-test-tube, with a tip that is closed off is secured in a particle beam device, such as a transmission electron microscope. The tip is engaged with the particle beam of the particle beam device until a hole opens up on the tip, thereby turning the high aspect ratio sample into a nano-pipet.

A nano-pipet having a hole that does not meet desired parameter values is secured in a particle beam device, such as a transmission electron microscope. The nano-pipet is engaged with the particle beam of the particle beam device to attain the desired values of the hole parameters.

### BRIEF DESCRIPTION OF THE SEVERAL VIEWS OF THE DRAWINGS

These and other features of the present invention will become apparent from the accompanying detailed description and drawings, wherein:

FIG. 1 shows a schematic cross sectional view of a hollow high aspect ratio sample according to an embodiment of the disclosure;

FIG. 2 is a transmission electron microscope taken picture of the tapered portion and the tip of a hollow high aspect ratio sample according to an embodiment of the disclosure;

FIGS. 3A-3B are schematic representations of a particle beam device used for fabricating a nano-pipet from a hollow high aspect ratio sample according an embodiment of the disclosure; and

FIG. 4 is a transmission electron microscope taken picture of a tapered portion and hole of a fabricated nano-pipet.

### DETAILED DESCRIPTION

Precise diameter holes at the end of a nano-test-tubes, often referred to as nano-pipets, find applications in a wide variety of endeavors in the fields of physics, biology, chemistry, and others. For example, nano-pipets may find uses for DNA sequencing. In order to distinguish individual molecules, the size of the nano-pipet hole, or opening, should be shrunk down to the sub-10 nm region. A process for reproducible production of nano-pipets with controlled hole sizes down to the nm regime would be useful for many applications.

Embodiments of the present invention teach nano-pipet fabrication. Embodiments of the invention allow to reproducibly produce nano-pipet holes, or openings, with precise desired characteristics, such as the diameter of the hole. The hole characteristics, or parameters, can be observed in real time during the fabrication and applied as feedback during processing. The embodiments teach the use of a particle beam device (PBD) in opening a hole in the tip of a high aspect ratio (HAR) sample, for instance a nano-test-tube, with the particle beam of the PBD. One may, of course, also take an existing nano-pipet and modify the hole.

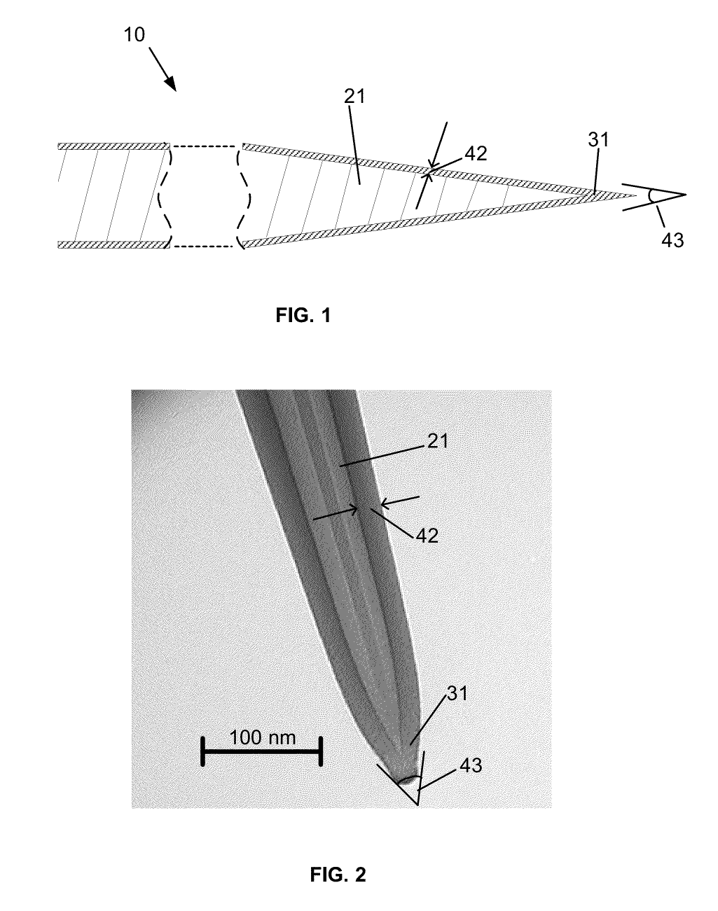

FIG. 1 shows a schematic cross sectional view of a hollow HAR sample according to an embodiment of the disclosure. Such a hollow HAR sample 10 may serve as starting point for applying the steps of the embodiments of the present disclosure in fabricating a nano-pipet. As the wavy and the dashed lines on the figure indicate, the hollow HAR sample may have a lengthy uniform section that is not needed to be shown in details. The hollow HAR sample 10 has a tapered portion 21 terminating in a tip 31. The length of the hollow HAR sample 10 may be anywhere between about 1 mm to 15 cm, but more typically between 1 cm and 3 cm.

The cross section of the hollow HAR sample typically, but necessarily, is circular. The hollow HAR sample 10 has a tip 31 that is closed off at the termination of the tapered portion 21. The term tapered portion it not meant to be understood in a limiting fashion. It is possible that the whole of the hollow HAR sample is tapered, or that the tapering is so short that it is practically indistinguishable from the tip.

The tip 31 in a typical embodiment of the present invention may be sharp, being in the regime of a few nm, possibly up to 30 nm, regime. The tip 31 of the tapered portion 21 may be characterized with tip parameters, such may be a wall thickness 42 of the hollow HAR sample 10 near the tip 31, and a tip angle 43, which is a measure of the degree of tapering. The wall thickness 42 may span a wide range of values. The wall thickness 42 may be as small as 0.5 nm to as large as being in the micrometer regime. The light hatching in the figure is only intended to mark empty space inside the hollow HAR sample. The hollow HAR sample may be regarded as a not fully formed nano-pipet, with the difference being that a nano-pipet has a hole at its tip.

In representative embodiments of the instant disclosure the hollow HAR sample may be made of drawn glass, or another quartz based material. FIG. 2 is a transmission electron microscope taken picture of the tapered portion and the tip of such a hollow HAR sample according to an embodiment of the disclosure. In many instances, as also in FIG. 2, the hollow HAR sample is a nano-test-tube. Such a nano-test-tube in some cases may have its own uses and fabricated in a manner to serve such possible uses. From the point of view of a typical embodiment of the present invention, such a nano-test-tube is regarded as a member to be fabricated into a nano-pipet. The tapered section 21, the tip 31, and tip parameters of wall thickness 42, and tip angle 43, are indicated as in FIG. 1. The scale of the picture is also given, showing the nanometer range of sizes related to the tip. The lightest shade in the center of the hollow HAR sample picture is a wave in the internal surface of the tube, with no particular interest for the representative embodiments of the instant disclosure.

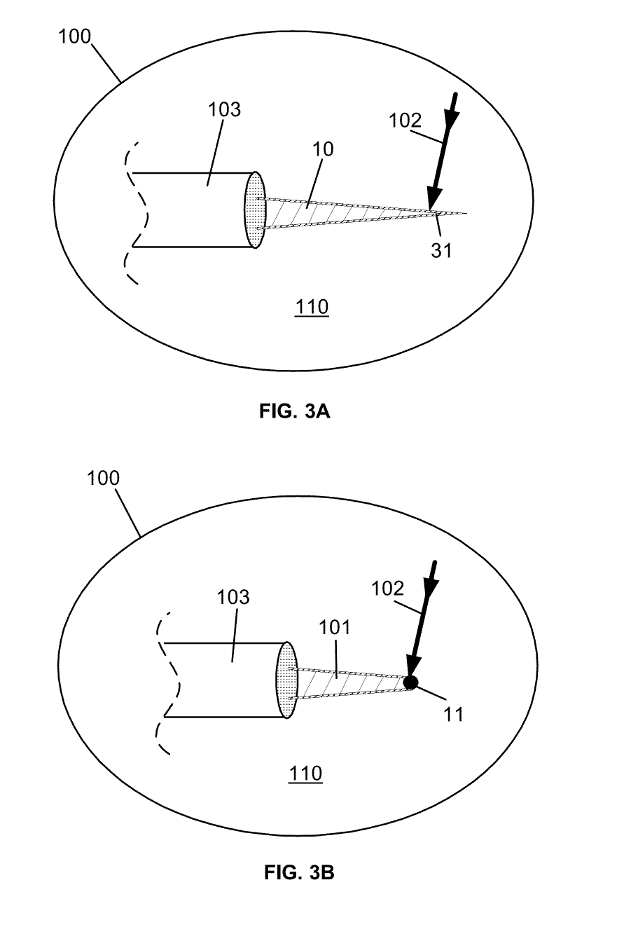

FIGS. 3A-3B are schematic representations of a particle beam device used for fabricating a nano-pipet from a hollow high aspect ratio sample according an embodiment of the disclosure.

FIG. 3A shows a starting stage in the fabrication of a nano-pipet. In the figure the hollow HAR sample 10 is shown as tapered, as it is often the case toward the tip 31 end. The hollow HAR sample is secured, namely firmly held in place, by a sample holder 103. Such PBD sample holders that are capable securing a hollow HAR sample 10, without the need of prior modification of the hollow HAR sample, have already been disclosed. Sample holders for securing a hollow HAR sample 10 are disclosed in U.S. patent application Ser. No. 13/629,193, filed on Sep. 27, 2012, which is incorporated herein by reference in its entirety.

The hollow HAR sample 10 is inside a PBD 100. FIGS. 3A-3B show the PBD 100 only symbolically because there are many such devices known in the art, and their details are not significant. In representative embodiments of the instant disclosure the PBD may be a transmission electron microscope (TEM). However, it is understood that this is by way of example only, and the embodiments of the present invention are applicable to other PBDs, such as scanning electron microscopes (SEM), or focused ion beam (FIB) systems.

The hollow HAR sample 10 is in such a position inside the PBD that the controllable particle beam 102 of the PBD is capable of engaging the tip 31 of the hollow HAR sample. This engaging by the particle beam 102 is done with such engaging parameters that a hole 11 opens up on the tip 31, whereby the hollow HAR sample 10 is transformed into a nano-pipet 101, shown in FIG. 3B.

The engaging parameters of the controllable particle beam 102 for the purposes of opening up the hole 11 may include particle beam intensity, beam diameter, duration of the engaging, and possibly others.

In representative embodiments of the instant disclosure the engaging particle beam 102 is an electron beam. With an electron beam, either in a TEM or an SEM, one may also image the tip 31, as is shown, for example, in FIG. 2. Such imaging may be done prior, during, and after the creation of the hole. Through such imaging one is capable to acquire tip parameters, such as the already introduced wall thickness 42 and the tip angle 43. The tip parameters may be used to optimize the engaging parameters. With optimized engaging parameters one can attain desired values for the hole parameters. Hole parameters may be many and various, depending on the intended use of the nano-pipet, but they would generally include hole diameter, smoothness of the hole perimeter, and the shape of the hole perimeter.

In representative embodiments of the instant disclosure the PBD is a TEM and the hollow HAR sample is a nano-test-tube made of drawn glass. The embodiments of the invention allow for high degree of precision and reproducibility in the nano-pipet fabrication. This is due to the ability of imaging the sample before, while, and after the hole forming process without the need to remove the sample from the PBD, or even from the sample holder. The same beam that is used to form the hole, is also used for the imaging that supplies the necessary parameters for an optimized hole. For the purpose of even more reproducibility and uniformity of holes, if after the beam engaging for creating the hole 11, the hole parameters are not of the desired values, one may repeat the engaging process by the particle beam 102, until one does attain the desired values of the hole parameters.

In alternate embodiments of the instant disclosure one may commence with a nano-pipet, which may have been produced by any method, and which has a hole parameter with a value that differs from the parameter's desired value. One may then engage the nano-pipet with the particle beam of the PBD to change the value and to attain the desired value for the hole parameter.

Typical engaging parameters in a TEM for an electron beam may be in the range of 30 kV to 400 kV with beam currents of nano to micro amperes, and with a beam diameter being the range of fraction of a nm to over a 1000 nm, typically to fit the dimensions of the tip 31, Representative engaging times may be as short as a few, maybe 5 seconds, up to a few minutes, but more typically not more than 1 minute.

FIG. 3B is similar to FIG. 3A but showing the final stage of the nano-pipet fabrication, with the hole 11 already formed, and the hollow HAR sample 10 turned into a nano-pipet 101. The particle beam 102 at this stage may be engaged in imaging for the purpose of ensuring the quality of the nano-pipet 101.

It is assumed that for hole forming the main effect of the particle beam 102 engagement is that of heating the region of the tip 31 of the hollow HAR sample 10. However, the ambient conditions 110 inside the PBD may also influence the process of hole creation. It may be possible that the ambient conditions 110 affect the degree of heating due to the particle beam 102, it also may be possible that the ambient conditions 110 affect the hole formation through chemical effects. In any case in representative embodiments of the instant disclosure one would select the ambient conditions 110 inside the PBD 100 in such manner to facilitate the formation of the hole.

The ambient conditions 110 inside the PBD 100 that are purposefully selected for optimal hole formation may include a gas pressure range. Such pressure range may be chosen to between about 10⁻³ ton and 10⁻⁷ torr, but more typically between about 10⁻⁴ ton and 10⁻⁵ torr. One may also select the precursor gases that can be present inside the PBD while conforming to the chosen pressure range. Precursor gases for hole formation or modification may be selected from oxygen containing, or hydrogen containing, or halide containing gases, and their admixtures.

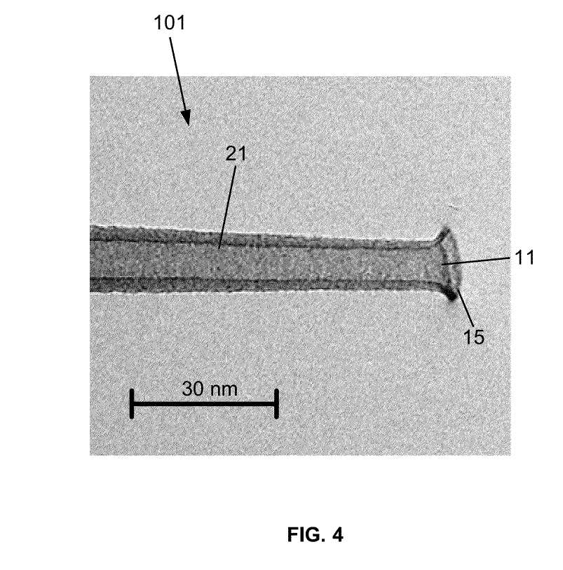

FIG. 4 is a transmission electron microscope taken picture of a tapered portion 21 and hole 11 of a nano-pipet 101 fabricated with the method of a typical embodiment of the present invention. The scale of the picture is also given to show the relevant sizes of the nano-pipet 101 device. The picture displays that in a characteristic and unique manner the perimeter 15 of the hole is shaped as a flared trumpet. Such flaring may be an indication of the method by which the hole 11 was formed. Such flaring may influence the capillary properties of the nano-pipet 101 and find useful applications, such as, and without limiting intent, influencing a flow rate through the nano-pipet 101.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

In addition, any specified material or any specified dimension of any structure described herein is by way of example only, without intent of restricting. Furthermore, as will be understood by those skilled in the art, the structures described herein may be made or used in the same way regardless of their position and orientation. Accordingly, it is to be understood that terms and phrases such as “under,” “upper”, “side,” “over”, “underneath”, “parallel”, “perpendicular”, “vertical”, etc., as used herein refer to relative location and orientation of various portions of the structures with respect to one another, and are not intended to suggest that any particular absolute orientation with respect to external objects is necessary or required.

The foregoing specification also describes processing steps. It is understood that the sequence of such steps may vary in different embodiments from the order that they were detailed in the foregoing specification. Consequently, the ordering of processing steps in the claims, unless specifically stated, for instance, by such adjectives as “before”, “ensuing”, “after”, etc., does not imply or necessitate a fixed order of step sequence.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature, or element, of any or all the claims.

Many modifications and variations of the present invention are possible in light of the above teachings, and could be apparent for those skilled in the art. The scope of the invention is defined by the appended claims.

1. A system, comprising:
a hollow high aspect ratio (HAR) sample of length between about 1 mm and 15 cm and having an end portion with a tip that is sealed;
a particle beam device (PBD) having a controllable particle beam and being capable of securing said hollow HAR sample in such manner that said tip can be exposed to said controllable particle beam;
wherein said controllable particle beam is capable of engaging said tip and opening up a hole in said tip, wherein said hole is between about 5 nm and 30 nm; and
wherein said system is characterized as being a setup for fabricating nano-pipets.

2. The system of claim 1, wherein said PBD is a transmission electron microscope (TEM) capable of imaging said tip, wherein said tip has tip parameters that can be obtained from said imaging, and wherein said engaging has engaging parameters that depend on said tip parameters.

3. The system of claim 2, wherein said engaging parameters comprise a particle beam intensity, a particle beam diameter, and a duration of said engaging.

4. The system of claim 2, wherein said hole has hole parameters with desired values, and said hole parameters can be derived from said imaging.

5. The system of claim 4, wherein said hollow HAR sample is a nano-test-tube made of drawn glass that has a wall thickness, and said tip parameters comprise said wall thickness and a tip angle.

6. The system of claim 1, wherein ambient conditions inside said PBD comprise between 10⁻³ torr and 10⁻⁷ ton of pressure, with a precursor gas selected from oxygen containing, or hydrogen containing, or halide containing gases, and their admixtures.

7. (canceled)

8. (canceled)
